(19) United States
(12) Patent Application Publication
(10) Pub. No.: US 2009/0200327 A1
(43) Pub. Date: Aug. 13, 2009

(54) Dispensing apparatus

(76) Inventor: William G. Jurkovich, Fresno, CA (US)

Correspondence Address: Rodney K. Worrel;WORREL & WORREL, St. Croix Professional Center, 2109 W. Bullard Avenue, Suite 121, Fresno, CA, 93711-1258, US

(21) Appl. No.: 12/069,854

(22) Filed: Feb. 12, 2008

(51) Int. Cl. G07F 11/00

(52) U.S. Cl. 221/3; 221/2

(57) ABSTRACT

A dispensing apparatus having a housing adapted to receive material to be dispensed, such as medication; a signal mechanism; and a closure for mounting the signal mechanism on the housing so as to be operable to provide a signal in a first position and a second position in which the closure is removed from the housing to provide access to the material to be dispensed therewithin.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field of the Invention

The present invention relates to a dispensing apparatus and, more particularly, to a dispensing apparatus which is operable to permit such dispensing to take place under preselected conditions.

(2) Description of the Prior Art

The dispensing of materials, objects, substances and the like of a wide variety of types frequently requires that the dispensing operation be performed under certain conditions and/or in accordance with predefined schedules. The management of these conditions, schedules, or the like, is dependent upon the parameters within which it is desired that use of the materials take place.

For example, the use of medications, pharmaceuticals and the like, requires, in virtually all instances, that they be taken, or consumed, at prescribed periods of time and under other specified conditions to ensure that they are efficacious. The prescribed periods of time may vary as, for example, once a day, or during general periods of the day, or at precise periods of time. The prescription may, for example, also specify that the medication be taken before eating, or after eating. The prescription may specify that one or more tablets, capsules, or the like be taken at a stated time, or times. There frequently are instructions as to food or activities to avoid before, during, or after taking the medication.

Heretofore, no reliable method or device has been known for taking the medication at the correct time prescribed for the given medication.

The most common conventional system for dispensing such substances involves simply placing the medication in a plastic pill bottle or container bearing the prescription instructions on a label on the outside of the container. This is, of course, too bulky conveniently to carry, particularly where several different medications must be carried in separate containers. There is nothing on the container, other than the label on the external surface thereof, to alert the person when the medication is to be taken.

The prior art additionally includes, among other systems, a container having a plurality of individual compartments. Each compartment has a moveable closure extending thereover which bears indicia relating in a generic manner to general periods of time. For example, the indicia may designate days of the week as well as general periods of time for each day such as “morning,” “noon,” “evening,” “bedtime” and the like. Referring to the instructions on the label of each pill container, the user places the medication in the appropriate compartment, or compartments, for each day of the week.

However, the person filing each compartment in the manner described by reference to the label may be limited in their capacity to do so. They may inadvertently, or for other reasons, place the medication in the wrong compartments. They may be personnel at, for example, a nursing home, who have too many such individual tenants, or patients, dependably to handle the operation as well as their other duties. The same hazards may, of course, be faced in any and all health care facilities including hospitals. Perhaps a more acute circumstance is where the prescription is for a person of limited capacity unable dependably to perform the task. For example, the elderly may become confused or otherwise unable to perform the operation.

In an attempt to remedy these difficulties, alarms have been employed for the purpose of reminding the person of the prescribed time for taking the medication. Most commonly, the medication is left in the original container. The alarm may be set on a wrist watch having this capability. Alternatively, the alarm of a clock, radio, or the like may be used. Such attempts have proven unsatisfactory for a number of reasons. For example, because of the exigencies of daily life, the person may not be near the alarm and so not hear it. The alarm may sound at an inconvenient time. As a result, the person may turn off the alarm at the time it sounds to take care of the activity of the moment with the intention of taking the medication thereafter at a more convenient time. Subsequently, the person may forget to take the medication at or near the prescribed time. In addition, the person may consequently forget whether or not the medication has been taken at the prescribed time. This frequently leads to under medication or over medication.

These problems have long been recognized, but never satisfactorily resolved. Furthermore, the situation has been exacerbated by the proliferation of drugs available for treating an increasing number of physical conditions. These hazards are recognized not only by those people directly involved, such as the manufacturers of the pharmaceuticals, physicians, pharmacists and patients, but also by insurance companies, governmental agencies and officials, various professional organizations and the media among others. For these and other reasons, the cost of health care to federal and state governments, businesses, individuals and the like have inordinately increased. As perplexing as these circumstances are, there has been no expectation that a solution would soon be found.

Therefore, it has long been known that it would be desirable to have an apparatus which is operable dependably to dispense materials; which has particular utility in dispensing pharmaceuticals and medications of all types; which ensures that the medication is taken at the prescribed time without fail, even at times which may otherwise be inconvenient; which can be employed with respect to a vast number of different types of medications; which is convenient to use while being fully reliable; which is of inexpensive construction for ease of production; and which is otherwise entirely successful in achieving its operational objectives.

### BRIEF SUMMARY OF THE INVENTION

Therefore, it is an object of the present invention to provide an improved dispensing apparatus applicable to the dispensing of a wide variety of materials.

Another object is to provide such a dispensing apparatus which ensures that the materials are dispensed at a preselected time.

Another object is to provide such a dispensing apparatus which has particular utility in dispensing pharmaceuticals, medications and the like which are to be taken at times prescribed by the manufacturers, physicians, pharmacists and the like.

Another object is to provide such a dispensing apparatus which has particular utility when used by personnel otherwise burdened by a multiplicity of duties which may distract them, or otherwise interfere, with their performance of the operation.

Another object is to provide such a dispensing apparatus which can dependably be employed by people having limited capabilities, or otherwise compromised in one or more respects.

Another object is to provide such a dispensing apparatus which alerts the user at the precise time for taking the contents thereof and cannot readily be circumvented.

Another object is to provide such a dispensing apparatus which maintains control of the dispensing operation without the conscious attention of the user.

Another object is to provide such a dispensing apparatus which possesses the capability of repeated usage in the performance of the dispensing operation.

Another object is to provide such a dispensing apparatus which assists in the precision with which medications can be dispensed while directly and by broader affect reduces the costs associated with health care.

Further objects and advantages are to provide improved elements and arrangements thereof in an apparatus for the purpose described which is dependable, economical, durable and fully effective in accomplishing its intended purposes.

These and other objects and advantages are achieved, in the preferred embodiment of the present invention, in a dispensing apparatus including a housing adapted to receive material to be dispensed, a signal mechanism and an attachment mechanism for securing the signal mechanism on the housing so as to be operable to provide a signal in a first condition and to provide access to the material to be dispensed in a second condition.

### BRIEF DESCRIPTION OF THE SEVERAL VIEWS OF THE DRAWINGS

FIG. 1 is an exploded, perspective view of the dispensing apparatus of the present invention showing the closure thereof in an open condition.

FIG. 2 is an enlarged external perspective view of the closure of the dispensing apparatus of the present invention.

FIG. 3 is a somewhat further enlarged, perspective view of the interior of the closure of the dispensing apparatus.

FIG. 4 is a perspective view of the closure showing portions of the exterior and interior thereof.

FIG. 5 is a somewhat reduced, exploded perspective view of the closure.

### DETAILED DESCRIPTION OF THE INVENTION

Referring more particularly to the drawings, the dispensing apparatus of the present invention in generally indicated by the numeral 10 in FIG. 1.

The dispensing apparatus 10 can be viewed generally as having a container or housing 20 and a lid or closure 21, as shown in FIG. 1.

Reference will first be made to the housing 20. The housing has a cylindrical wall 30 having a lower end portion 31 and an upper end portion 32. The cylindrical wall can be transparent to reveal the contents of the housing therethrough, or nontransparent so as to conceal the contents thereof. The lower end portion has a bottom wall 33 which is contiguous with the cylindrical wall so as to form a closed end portion of the container. The cylindrical wall 30 has a cylindrical exterior surface 34 and cylindrical interior surface 35. The interior surface bounds, or defines, an interior compartment 36 of the housing.

The upper end portion 32 of the cylindrical wall 30 has an annular edge 50 bounding a mouth 51 of the housing 20 which communicates with the interior compartment 36. A securing assembly, generally indicated by the numeral 52 in FIG. 1, circumscribes the mouth of the housing. The securing assembly includes an outwardly tapered surface 53 which extends from the annular edge 50 outwardly and downwardly generally toward the lower end portion 31. The securing assembly has an intermediate ring 54 extending about the upper end portion of the cylindrical wall 30 between the tapered surface 53 and the upper end portion.

Five (5) latch members 55 are mounted on and extend outwardly from the intermediate ring 54 in predetermined, equally spaced relation to each other. Each latch member has an upper surface 56 and an opposite lower surface 57. Each latch member has a leading end portion 58 and an opposite trailing end portion 59. The lower surface of each latch member has a sloped surface extending downwardly from the leading end portion toward the trailing end portion. The sloped surface communicates with a recess, or notch, 61 adjacent to the trailing end portion 59. Each latch member has an outer surface 62. As shown in FIG. 1, the outer surface of each latch member is curved concentric to the intermediate ring 54.

The closure 21 is adapted removably to be mounted on the upper end portion 32 of the cylindrical wall 30 of the housing 20, as will hereinafter be discussed in greater detail. The closure has a main cylindrical wall 70 having a lower annular ring or edge 71 and an upper annular ring or edge 72. The main cylindrical wall has an exterior surface 73 and an interior surface 74. A plurality of grasping ridges 75 are provided on the exterior surface extending between the lower annular edge and the upper annular edge 72 and in substantially right angular relation thereto. The plurality of grasping ridges preferably extend in substantially parallel relation to each other and entirely about the exterior surface of the main cylindrical wall.

A plurality of securing members 80 are mounted on the interior surface 74 of the main cylindrical wall 70 of the closure 21. There are preferably, although not necessarily, five (5) such securing members which are disposed in equally spaced relation to each other and corresponding to the spacing of the latch members 55. Each of the securing members has an upper surface 81 and an opposite lower surface 82. Each of the securing members has a leading surface 83 and an opposite trailing surface 84. Each of the securing members has an inner surface 85. The inner surface of each securing member defines and arc substantially parallel to the interior surface 74 of the closure 21, as best shown in FIG. 3.

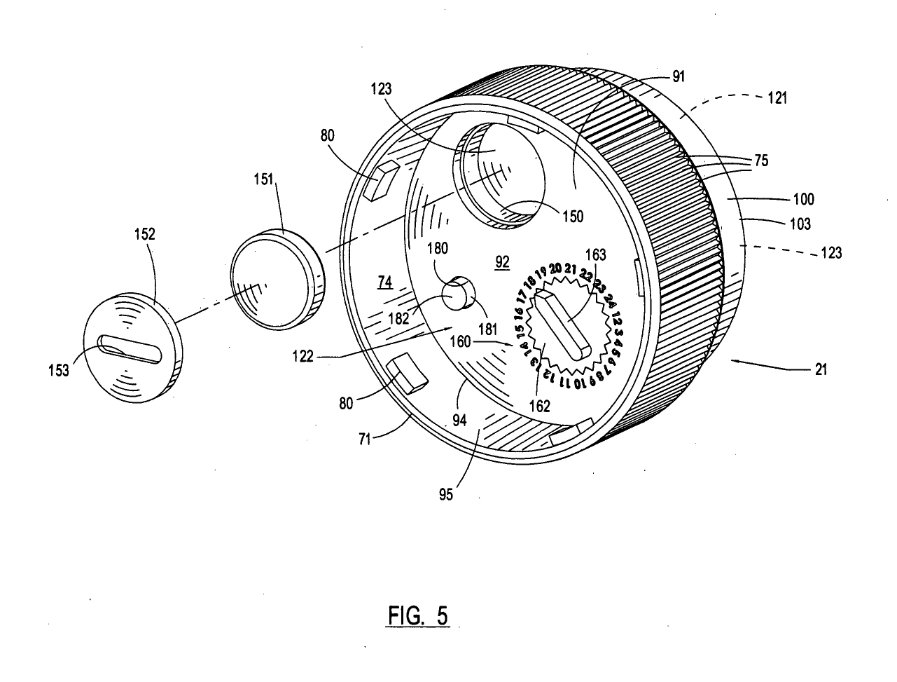

The closure 21 has a control housing 90 which is mounted on the main cylindrical wall 70 of the closure 21, as hereinafter described. The control housing has a lower wall 91 having a lower surface 92 and an opposite upper surface 93. The lower wall has a circular outer peripheral edge 94 which is mounted on the cylindrical wall 30 at the upper annular edge 72 thereof. The interior surface 74 of the main cylindrical wall 70 of the closure 21 and the lower surface 92 of the lower wall 91 of the control housing define an interior compartment 95 of the closure 21. The lower surface 92 of the lower wall 91 is recessed from the lower annular edge 71 to define the interior compartment 95, as best shown in FIG. 5.

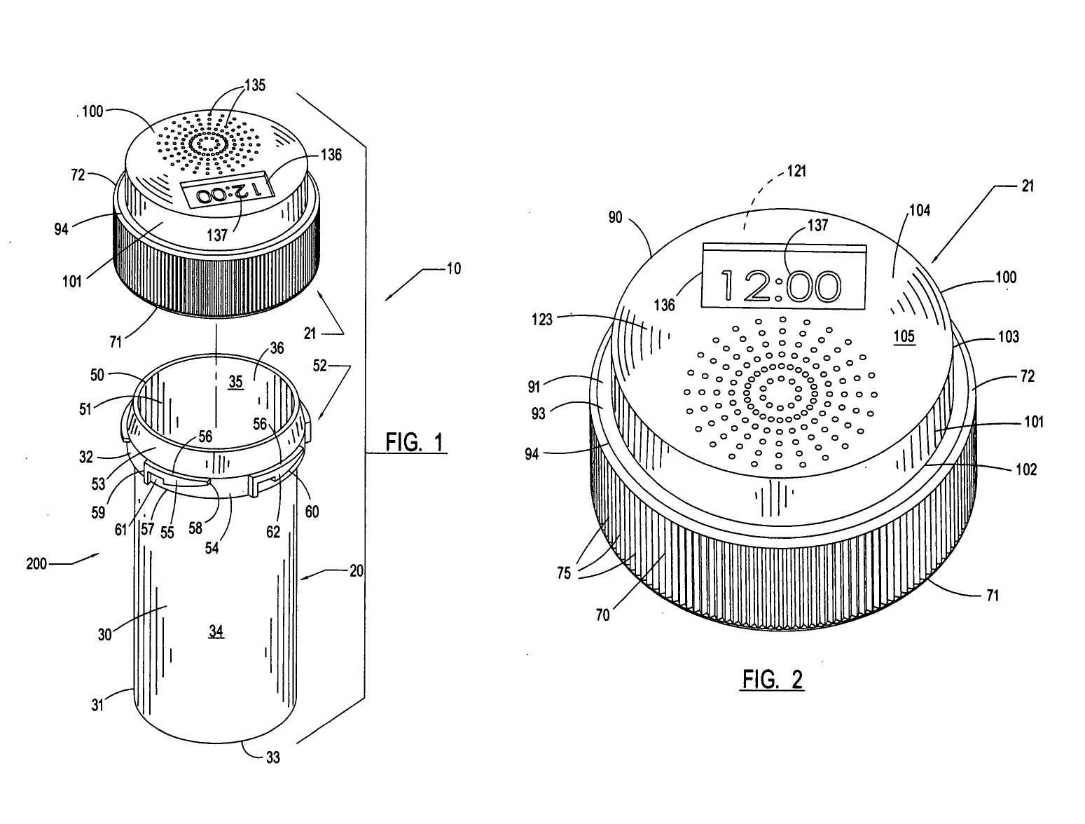

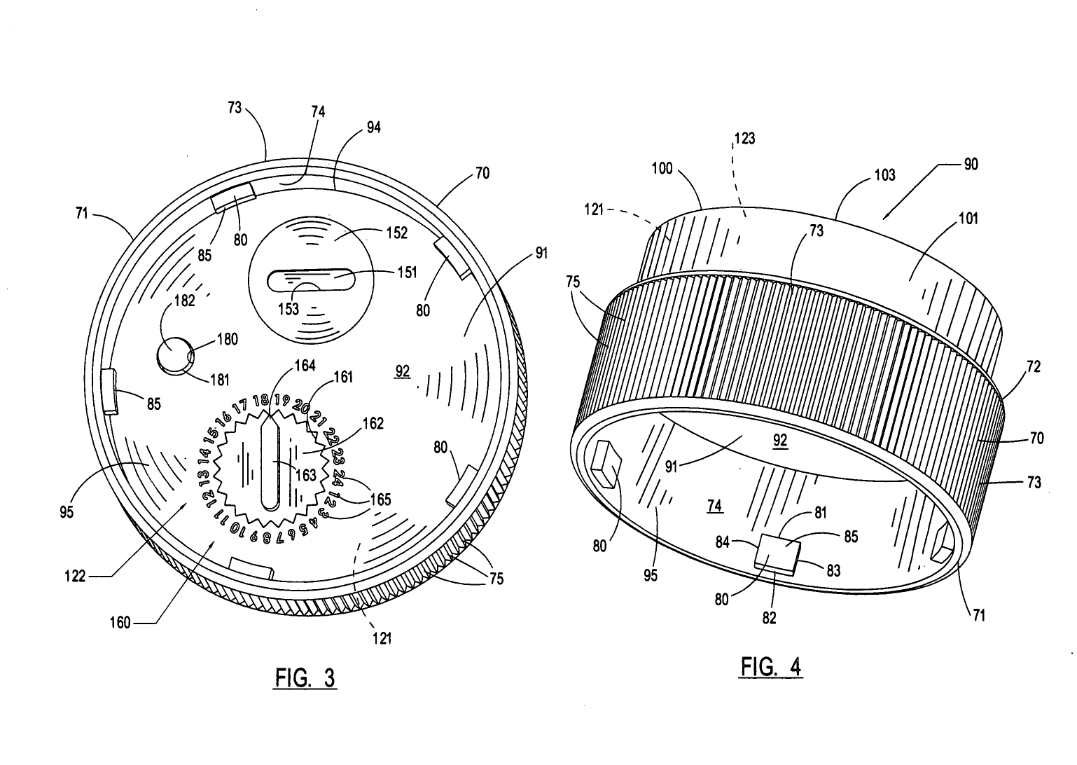

An upper cover 100 is mounted on the lower wall 91 of the control housing 90. Preferably, although not necessarily, the upper cover 100 and the lower wall are of integral construction. The upper cover has a cylindrical sidewall 101 which is substantially concentric to and recessed from the upper annular edge 72 of the main cylindrical wall 70, as best shown in FIG. 2. The cylindrical sidewall 101 has a circular lower edge 102 and a circular upper edge 103. A circular top wall 104 is mounted on and integral with the upper edge 103 of the cylindrical top wall and has an upper surface 105.

The control housing 90 has a signal mechanism, or alarm system, generally indicated by the numeral 120 in FIGS. 3 and 5. The alarm system includes a main alarm assembly generally indicated by the numeral 121 in FIGS. 2, 3 and 5. The alarm system has a main control assembly generally indicated by the numeral 122 in FIGS. 3 and 5. The main alarm assembly 121, in the preferred embodiment, is housed in a main alarm compartment 123 defined by and fully contained between the lower wall 91 of the control housing 90 and the upper cover 100. The main control assembly 122 is fully contained within the interior compartment 95 of the control housing 90, as shown in FIGS. 3 and 5. Thus, the main control assembly 122 is accessible only by removal of the closure 21 from the housing 20, as will hereinafter be described in greater detail.

The main alarm assembly 121 has a suitable electrical system 124 which preferably, although not necessarily, is embodied in an electronic circuit 125 contained on an electronic circuit board, semiconductor, electronic chip, or the like, 126. The electrical system is operably connected to an audio signal, or alarm, 127 which is operable to emit a sound under the control of the alarm system 120, as will hereinafter be discussed in greater detail. The sound can be of any desired form such as a buzz, tone, bell, or the like. Similarly, the sound can be continuous or intermittent and can continue for any desired period of time under the control of the alarm system. For example, the sound can be continuous for a period of fifteen (15) seconds under the control of the alarm system.

Similarly, the alarm system is operably connected to a vibratory signal, or alarm, 128. The vibratory alarm is operably connected to the alarm system and is operable to vibrate under the control of the alarm system 120. The vibratory alarm 128 can be operable to vibrate in any desired manner, such as a continuous or intermittent rapid oscillation. The vibration can be for any desired period of time, such as, for example, fifteen (15) seconds. The time and/or order of the sound and vibration can be of any desired period and sequence. In the preferred embodiment, the sequence is first the vibratory energy produced by the vibratory alarm and, subsequently, the sound energy produced by the audio alarm. There can be a delayed period of time between activation of the vibratory alarm and the audio alarm. In the preferred embodiment, during the production of vibratory energy by the vibratory alarm, no sound is emitted. Similarly, during the production of sound energy by the audio alarm, no vibratory energy is produced.

A plurality of perforations, or holes, 135 are formed in and extend through the top wall 104 of the upper cover 100. The holes are for the purpose of better emitting the sound energy produced by the audio alarm 127 and, if applicable, the vibratory energy emitted by the vibratory alarm 128.

A digital display 136 is mounted in the top wall 104 of the upper cover 100. The digital display is operable to display numerals 137 which represent a period of time, as will hereinafter be described in greater detail.

As best shown in FIGS. 3 and 5, the main control assembly 122 is disposed within the interior compartment 95 of the closure 21. Thus, in the preferred embodiment, the main control assembly is accessible to the user only when the closure 21 is removed from, or, in other words, not attached to, the housing 20. When the closure is mounted on, or otherwise attached to, the housing, the main control assembly is not accessible. The main control assembly includes a battery receptacle 150 which extends through the lower wall 91 into communication with the main alarm compartment 123. An electrical battery 151 is adapted operably to be received in the battery receptacle in operable engagement with the alarm system 120. A battery closure 152, having a grasping opening 153, is received in the battery receptacle so as to capture the electrical battery therewithin in operable engagement with the alarm system 120. The battery closure is selectively removable from the battery receptacle, using the grasping opening 153, for replacement of the electrical battery.

The main control assembly 122 is operably connected to a timer assembly generally indicated by the numeral 160, as shown in FIGS. 3 and 5. More specifically, the timer assembly has a dial opening 161 which extends through the lower wall 81 of the control housing 90. A dial 162 is operably mounted within the dial opening in operable engagement with the main control assembly 122. The dial mounts a grasping member 163 having an indicator point 164 at one end thereof. A plurality of time indicator numerals 165 are displayed on the lower surface 92 of the lower wall 91 in equally spaced relation to each other and extending entirely about the dial, as best shown in FIG. 3. In the preferred embodiment of the invention there are twenty-four(24) numerals extended in equally spaced relation about the dial with each numeral representing one hour of a twenty-four hour time period, or fraction thereof. Of course, any number and type of characters can be used to represent any particular period of time or other information.

A control passage 180 extends through the lower wall 91 of the control housing 90 and communicates with the main alarm compartment 123. A reset and alarm shut off member 181 is slidably received in the control passage and has an outer end portion 182 resiliently biased to an outwardly extending position, as shown best in FIG. 5. An interior end portion of the reset member is disposed in operable connection to the alarm system 120 within the main alarm compartment 123. The reset member is moveable in the control passage 180 between an extended position, shown in FIGS. 3 and 5, and a depressed position. In the depressed position, the reset member operates to shut off the audio alarm 127 and the vibratory alarm 128. The reset member also at this time to reset the digital display 136 to numerals 137 indicating zero (0) or a new starting indication to indicate as new starting point for reasons subsequently to be discussed.

It will be understood that when the closure 21 is releasably attached to or mounted on the housing 20, for purposes of illustrative convenience, the dispensing apparatus 10 will be referred to being in a first condition, or position, not shown. When the closure 21 is detached or removed from the housing 20, for purposes of illustrative convenience, the dispensing apparatus will be referred to being in a second condition, or position, shown in FIG. 1 and generally indicated by the numeral 200.

### Operation

The operation of the described embodiment of the subject invention is believed to be clearly apparent and is briefly summarized at this point.

In the most continuous period of usage, the dispensing apparatus 10 is in the first condition or position of usage; that is, with the closure 21 releasably mounted on, or attached to, the housing 20. In this first condition, the closure is mounted on the housing with the securing members 80 of the closure individually received in the notches 61 of the latch members 55 of the housing. This configuration places and retains the lower annular edge 71 of the closure in engagement with the annular edge 50 of the housing. In this first condition the dispensing apparatus is thus in a closed configuration.

Removal of the enclosure 21 from the housing 20 is achieved by pressing the enclosure and/or the housing toward each other. This action moves the securing members 80 of the closure toward the housing and thus out of the notches 61 of their respective latch members 55. The closure is then rotated in a counterclockwise direction, as viewed in FIG. 1, about the longitudinal axis of the closure and housing. This causes the securing members 80 to slide along the sloped surfaces of their respective latch members. Upon reaching the trailing end portions 59 of their respective latch members, the securing members 80 are thus completely released from their respective latch members 55. The closure can then fully be removed from the housing to expose the interior compartment 36 of the housing. The dispensing apparatus 10 is thereby placed in the second condition, or position, 200, as shown in FIG. 1.

In this second condition 200, the interior compartment 36 of the housing is completely exposed and can be filled with the number of materials to be dispensed, such as pills, tablets, capsules, caplets or the like, prescribed by the doctor, or other authorized personnel. In the illustrative example, these materials to be dispensed individually contain medication to be taken in accordance with a doctor's prescription and instructions are printed on a label affixed to the exterior surface 43 of the housing.

The filling of the prescription and placing the medication in the dispensing apparatus 10 can be by a pharmacist, doctor, or by other trained and authorized personnel. In other instances, the medication may be received by a patient, or other user, in a conventional container. Thereafter, the medication is transferred to the dispensing apparatus of the present invention for operation and use, as hereinafter described. In either case, a label can be affixed to the exterior surface 34 of the housing 20 providing instructions for taking the medication.

Subsequently, the dispensing apparatus 10 is set in its operating configuration. Referring to the instructions of the label of the conventional container received from, for example, the pharmacy and/or the instructions on the label affixed to the exterior surface 34 of the dispensing apparatus, the alarm system 120 is adjusted or set for operation and use. More specifically, as best shown in FIGS. 3 and 5, the operative elements of the main control assembly 122 are set for use. It will be understood that in all situations the main control assembly 122, and thus the alarm system 120, are not activated until they are set. Thus, the various systems of the dispensing apparatus previously identified are not operable.

The setting of the systems of the dispensing apparatus 10 is achieved by placing the timer assembly 160 in the setting corresponding to the prescribed instructions on the label and/or labels. Using the grasping member 163, the dial 162 is turned until the period of time which is to elapse before next taking the prescribed medication is indicated by or pointed to by the indicator point 164 of the grasping member. For example, if the next dosage of medication is to be taken by the patient as prescribed once per day, the dial is turned until the indicator point is directly opposite to, or pointing at the time indicator numeral “24” which means in twenty-four (24) hours. If the dosage of medication is to be taken once every morning, for example, the timer assembly 160 is set each morning immediately after the patient takes the morning dosage.

At the same time, the reset and alarm shut off member 181 is depressed. This causes the alarm system 120 to place the digital display 136 in the condition such that the numerals 137 indicate “00:00.” Conversely, if desired, the alarm system 120 and digital display 136 can be designed so that the depression of the reset and alarm shut off member causes the digital display to register the amount of time set by movement of the dial 162 of the timer assembly 160. In the above illustrative example, the numerals 137 would indicate “24:00.”

In either case, the next step after taking the prescribed dosage of medication is to place the closure 21 in the secured or closed position of the housing 20. This has herein, for illustrative convenience, been identified as the first condition or position. This is achieved by placing the closure 21 in aligned and covering relation to the interior compartment 36 of the housing. The closure is then pressed toward the housing to cause the securing members of the closure individually to be passed between adjacent latch members 55 of the housing. The closure is then rotated in a clockwise direction, as viewed in FIG. 1. The securing members 80 are thereby passed along the sloped surfaces 60 of their respective latch members until they resiliently snap into the notches 61 thereof. The dispensing apparatus 10 is thereby placed in a sealed, or closed, condition with the medication to be dispensed confined within the interior compartment 36 of the housing.

The dispensing apparatus 10 is then placed in a location for storage such as the patient's pants pocket, shirt pocket, purse, or the like. The dispensing apparatus can also, for example, be placed on a table near a bed, or other furniture, in which the patient will lay or be seated. Still further, the dispensing apparatus can be placed in such locations as nurses' stations, stations of other health care workers, or like or near other people who will actually be using the dispensing apparatus to dispense the prescribed dosage of the medication to the patient.

Subsequently, when the designated period of time for the next dosage has expired, in the preferred embodiment, the alarm system 120 first activates the vibratory alarm 128. The vibratory energy thereby released causes the dispensing apparatus to vibrate in such a manner as to alert the person who is to take the dosage of medication. This vibratory energy can be felt in a pants pocket, a shirt pocket, or the like. In a purse, bag, or other container, the vibratory energy is detected by vibratory contact of the dispensing apparatus with the container itself or items therewithin. Where the dispensing apparatus has been laid on a supporting surface such as that of a table, or the like, or, for example, a shelf in a nurse's station, such vibrating contact with the supporting surface will alert those in vicinity.

When this preselected period of operation of the vibratory alarm has elapsed, the alarm system 120 terminates operation of the vibratory alarm 128. With or without a preselected delay, the alarm system 120 then activates the audio alarm. The audio alarm emits the alarm sound which is projected from the closure 21 with the aid of the holes 135 of the upper cover 100 of the closure. The alarm continues to emit the alarm sound for the designed period of time. This designed period of time can be continuous until the closure is placed in the second condition, or position, 200 and the reset and alarm shut off member 181 is depressed. Alternatively, the designed period of time can be a fixed period of time even if the closure is not removed and the reset and alarm shut off member is not depressed. In the preferred embodiment, the alarm sounds continuously until it is shut off as previously described.

The foregoing mode of operation ensures that the prescribed dosage of medication is taken at the prescribed time. The user cannot simply shut off the alarm, including the vibratory alarm or the sound alarm, without removing the closure 21 from the housing 20 to do so. This ensures that the user takes the medication at the prescribed time because the dispensing device must be opened in any and all cases. Thus, the user cannot shut off either alarm without removing the closure from the housing. Since the housing is thus open, the dosage of medication can readily be taken rather than simply shutting off the alarm for taking the medication at a more convenient time. Thus, the user cannot run the risk of forgetting to take the medication.

Therefore, the dispensing apparatus of the present invention is operable dependably to dispense materials; has particular utility in dispensing pharmaceuticals and medications of all types; ensures that the medication is taken at the prescribed time without fail, even at times which may otherwise be inconvenient; can be employed with respect to a vast number of different types of medications; is convenient to use while being fully reliable; is of inexpensive construction for ease of production; and is otherwise entirely successful in achieving its operational objectives.

Although the invention has been herein shown and described in what is conceived to be the most practical and preferred embodiment, it is recognized that departures may be made therefrom within the scope of the invention which is not to be limited to the illustrative details disclosed.

Having described my invention, what I claim as new and desire to secure by Letters Patent is:

1. A dispensing apparatus comprising a housing adapted to receive material to be dispensed, a signal mechanism and means for mounting the signal mechanism on said housing so as to be operable to provide a signal in a first condition and to provide access to said material in a second condition.

2. The dispensing apparatus of claim 1 wherein said mounting means is a closure operable to be mounted on the housing in said first condition and to be separated from the housing in said second condition.

3. The dispensing apparatus of claim 2 wherein the closure is adapted to be placed in the first condition and the second condition by an operator selectively moving said closure relative to said housing.

4. The dispensing apparatus of claim 3 wherein the signal mechanism is mounted substantially completely within said closure, said first condition is a first position of the closure in engagement with said housing to close the housing and said second condition is a second position of the closure disengaged from the housing to open the housing for access to said material to be dispensed.

5. The dispensing apparatus of claim 4 wherein said signal mechanism has a timer adapted selectively to be set to measure a predetermined period of time and an alarm activated by the timer when said predetermined period of time has elapsed.

6. The dispensing apparatus of claim 5 wherein said closure has an internal portion which is not accessible when the closure is in said first position and is accessible when the closure is in said second position and the signal mechanism is operable substantially only from said internal portion of the closure.

7. The dispensing apparatus of claim 6 wherein the timer of the signal mechanism has a dial within said internal portion of the closure operable selectively to be set to measure said predetermined period of time.

8. The dispensing apparatus of claim 7 wherein said closure has an outer portion having a display operated by said timer to indicate the elapsing of said predetermined period of time when the closure is in said first position.

9. The dispensing apparatus of claim 8 wherein the timer and display are operable to register said predetermined period of time in increments thereof.

10. The dispensing apparatus of claim 9 wherein said alarm is operable by the timer first to emit a vibrating signal when said predetermined period of time has elapsed and second to emit an audible signal and both the vibrating signal and the audible signal are detectable by the operator.

11. The dispensing apparatus of claim 9 wherein said alarm has a depressible member mounted on said internal portion of the closure which is accessible only in said second position of the closure and operable when depressed to terminate said alarm.

12. The dispensing apparatus of claim 9 wherein said signal mechanism has a power source operably connected to the timer and the alarm to provide power thereto and which is replaceable when said closure is in the second position.

13. The dispensing apparatus of claim 12 wherein said internal portion of the closure and the housing mount means for releasably interlocking the closure and the housing in said first position.

14. The dispensing apparatus of claim 13 wherein said material to be dispensed is medication to be taken at a predetermined period of time, the timer is adapted to be set when the closure is in said second position to operate the alarm when the predetermined period of time has elapsed and the alarm can only be terminated when the closure is in the second position by depressing said depressible member whereby the alarm continues to operate until said medication is accessible, thereby preventing termination of the alarm until the medication is accessible substantially to prevent the operator from the avoidance of taking the medication from the housing at said predetermined period of time so as substantially to insure consumption of the medication at said predetermined period of time.

15. The dispensing apparatus of claim 14 wherein the housing is substantially transparent to reveal the medication therewithin.

16. The dispensing apparatus of claim 14 wherein said housing is a container for use in the consumption of a prescribed medication and said closure is a cap releasably interlockable with said container.
